(19) United States
(12) Patent Application Publication
(10) Pub. No.: US 2010/0077681 A1
(43) Pub. Date: Apr. 1, 2010

(54) Utility floorbox for use with ice covered floors

(76) Inventor: Michael McCleskey, Calabasas Hills, CA (US)

Correspondence Address: KOPPEL, PATRICK, HEYBL & DAWSON, 2815 Townsgate Road, SUITE 215, Westlake Village, CA, 91361-5827, US

(21) Appl. No.: 11/498,012

(22) Filed: Aug. 1, 2006

(51) Int. Cl. E04C 2/52; E04B 1/66; H02G 3/08

(52) U.S. Cl. 52/220.1; 52/745.16; 220/592.01; 220/3.3; 220/3.8

(57) ABSTRACT

A utility floorbox for use with ice covered floors which is constructed with a housing or frame having a cover and a sealing member therebetween so that access can be obtained to the interior of the floorbox for accessing the utilities therein. The floorbox is water tight, so that it does not interfere with utility applications, such as electrical applications. A cover is provided with the floorbox and is designed to withstand heavy loads which may be imposed on the floor by utility trucks, or the like.

### BACKGROUND OF THE INVENTION

1. Field of the Invention

This invention relates in general to certain new and useful improvements in utility floorboxes, and, more particularly, to utility floorboxes which are capable of being used with ice covered floors and which floorboxes are readily and easily accessible for obtaining access to utility connections, when ice is not located on the floor. More particularly, the floorbox is designed so it will withstand the harsh environment of a subfreezing temperature and heavy weight imposed thereon and will remain waterproof, but which is highly effective in providing utility connection. The floorbox represents a much more advanced design than any previous floorbox designs for use with ice covered floors.

2. Brief Description of Related Art

Utility connection floorboxes are well known and one effective utility floorbox for use with floors, and particularly floors of indoor facilities, is taught in my U.S. Pat. No. 6,061,983 dated May 16, 2000, for Removable Utility Connection Floorbox and Method.

Utility floorboxes are frequently installed in large facilities, such as convention centers, auditoriums and the like, where access to various types of facilities may be required. Usually, the floorbox is located in the base construction of the building, such that it has an upper surface or lid which may be generally contiguous with the surface of the floor. These utility floorboxes are effective in providing access to utilities, as for example, exhibitor utilities, including, e.g., electrical power, telecommunications, audiovisual communication systems, compressed air, water, and drain facilities.

The floorbox of the type described in the aforesaid patent enables the facility to be altered for different uses. As a simple example, in one case, the facility may be used as a large open convention auditorium where individuals are seated on chairs located on the floor, and in other cases, it may be used for merchandise display, where individuals set up displays, or display booths, for retailing of their merchandise. The number of uses of these utilities are essentially endless but, access to various types of utilities must be made available so that the facility will fit the needs of the particular groups who may wish to rent that facility.

The use of a utility floorbox in an ice covered floor presents a totally different type of environment and it presents requirements which are not associated with a conventional dry floor facility. However, the floorbox in a sub-ice floor-covered facility must not only meet the requirements for a dry floor space floorbox, but it must also have the added advantages of providing dryness, significant vehicular weight support and one which would not interfere with the formation of the ice and the retention of the ice on the floor itself.

The previous attempts to provide ice-floor floorboxes were, at best, very crude. Typically, the contractors attempting to build the floor construction did not have the availability of pre-formed ice-floor floorboxes. Rather, these floorboxes were make-shift constructed at an on-site location. As a result, the floorboxes were not designed to withstand the harsh environment which floorboxes located in a ice floor environment must withstand. Typically, these previous floorboxes for ice-covered floors were not only crude, but since they were constructed at an on-site location and by workmen who were not familiar with the important requirements of these floorboxes, they were typically quite inferior. The joints in the construction of the floorbox were poor and, hence, waterproofing was virtually impossible.

The prior art floorboxes also were inadequate in that no provision was usually made for draining of melted ice. If drains were not present, there were frequently leaks into the floorbox cavity and the boxes often filled with water interfering with utility operation. As a simple example, the water seepage into the floorbox frequently shorted electrical conductors and also entered utility lines causing numerous utility problems. Even more so, the floorboxes were not necessarily provided with drains to remove the leaking water, as aforesaid, and, hence, it was easy for the boxes to fill with water, thereby eliminating one of the critical requirements for the floorbox, namely dryness.

In many cases, when the floorbox was constructed on-site and without any prepared plans for construction, in order to obtain some dryness for the floorbox, a waterproofing material was placed over the floorbox. Even if the waterproofing material was effective in keeping the floorbox dry, it also interfered with the formation of ice on the floor. As a result, the ice over the floorbox was usually soft and oftentimes melted because of the heat sink effect of the steel plate at the top portion of the floorbox. Moreover, these prior art designs required the brine piping to be routed around the floorbox in the concrete. This also left a large area where there was no cooling capability and, hence, there were soft spots in the ice on the floor. As a result, if skaters were using the ice floor, and when they passed over the floorbox, they found that the ice was too soft for skating. In some cases, the soft ice led to falls with the inevitable resultant liabilities arising therefrom. Moreover, because of the poor ice conditions on these floors, the rentability of the facility and, hence, the profitability of that facility, suffered.

In many cases, the construction industry fosters a belief that it is not possible to build a floorbox in the floor of an ice-floor facility, such as an arena or the like. As a result, many of these floors are not provided with floorboxes and, hence, the functionality of the entire facility is limited. Otherwise, there are no floorboxes and, hence, it is virtually impossible to connect two various utilities when ice is not used on the floor.

It would be highly advantageous to provide a floorbox assembly which is not only water tight, but does not interfere with the maintaining of an ice floor over that floorbox and which also provides for access to utilities, when required.

### OBJECTS OF THE INVENTION

It is, therefore, one of the primary objects of the present invention to provide a utility floorbox assembly for use with an ice-covered floor which allows for formation of the ice, without interference, such that the ice thickness and hardness over the floorbox is contiguous with the ice condition surrounding the floorbox.

It is another object of the present invention to provide a utility floorbox assembly for sub-ice floor installations and which is used to provide access to various types of exhibitor utilities, such as electrical utilities, compressed air, water, drain utilities, and telecommunication utilities, and the like.

It is a further object of the invention to provide a sub-ice floor mounted floorbox assembly which is water tight and is secure against melting water entering the interior of the floorbox.

It is still another object of the present invention to provide a sub-ice floor mounted floorbox assembly which not only provides physical protection against extremely heavy wheel traffic, such as vehicular traffic, including forklift truck traffic and the like, but also which enables access to utilities when an ice floor is not used, without any modification, whatsoever, of the floorbox.

It is an additional object of the present invention to provide a floorbox design which can meet utility laboratory ratings, such as ETL ratings or UL ratings, and also meets construction ratings for withstanding heavy loads.

It is another salient object of the present invention to provide a method of enabling access to the various utilities, under a floor construction of a facility, and without compromising the security of each of the utilities located in that facility and which is effective for use with dry floor conditions and ice-covered floor conditions.

It is still another object to provide a method of mounting a floorbox in a floor upon which ice may be located on the surface of the floor and which is maintained by a coolant piping system constructed in such manner that the floorbox will operate so that heat is conducted away from the floorbox thereby ensuring an evenness of ice on the floor over the floorbox and the area surrounding the floorbox.

With the above and other objects in view, my invention resides in the novel features of form, construction, arrangement and combination of parts and components presently described and pointed out in the claims.

### SUMMARY OF THE INVENTION

The present invention provides, in broad terms, a utility floorbox assembly which may be mounted in floor and preferably in a condition where the upper surface of that floorbox, including a cover for that floorbox, is contiguous with the level of the floor. Moreover, the upper surface of the floorbox, or a cover therefor, may be designed so that it has a surface finish similar to that of the remaining portion of the floor. In this way, the floorbox can be used for dry floor activities, and the surface or cover of the floorbox may also be flooded with water and cooled to function as an ice skating rink, or the like.

The present invention, in broad terms, is therefore designed to provide access to exhibitor utilities, including, for example, electrical power, telecommunications, audiovisual services, various data communication links, compressed air, water supply, and even drain facilities. The various facilities would normally be available in convention halls, exhibitor locations and the like.

As indicated previously, many of these arenas, exhibitor halls or convention facilities do not provide for the use of ice floors, and, hence, they are limited in that they cannot also function as an ice-skating rink or an ice-hockey field, etc. The present invention thereby provides a floorbox design which is capable of being used with dry floors or with ice-covered floors. In order to provide for access to facilities, the floorbox, of course, necessarily solves the above and related problems.

The present invention is comprised of four major pieces forming part of the floorbox. There is initially provided two metal sheathed gaskets of the type used in flange joints of high pressure gas pipelines. Further, there is the floorbox and a cover having hinged sections thereon and which is disposed over a frame on the floorbox. A rim is designed for use with the frame of the floorbox and aids in carrying the brine pipes adjacent to the floorbox assembly.

The metal sheathed gaskets in communication with the cover and the rim and the frame will conduct heat away from the assembly and eventually to the brine or other coolant. There is also provided a rim of the floorbox which is integrated into a coolant, e.g., a brine piping system, the latter of which may be chilled to a temperature below 32° F. (0° C.) and circulated through piping embedded in the floor slab, typically plastic piping. The floorbox design also comprises a frame which is integrated into the brine piping system. This device will also use a heat sink conducting paste and provides a frame for the brine piping.

In my previous U.S. Pat. No. 6,061,983 dated May 16, 2000, the floorbox for the utility services was deliberately isolated from contact with the concrete floor. The present box is designed to maximize contact with the concrete surrounding the box in order to form a single isotherm. In substance, the floorbox assembly uses a metal-to-metal path for conducting heat away from the cover of the system. Moreover, the cover will be at least as cold as the concrete floor surrounding the utility box.

The cover is an important item in the floorbox assembly of the present invention and includes several components. First of all, there is a cover bridge which covers the central portion of the utility box. Moreover, the cover must support a very heavy wheel load, such as from forklift trucks, or the like. In addition, there are two utility access plates located at the opposite ends of the cover and which are located to provide access to utility lines. Hinges are required so that access to the utilities may be obtained. Moreover, they will rest on the surface when not in use. The hinges are double-pin hinges, so that there is a 180° access opening, but which would still present a flat floor when not in use.

The utility floorbox is actually a rectangularly shaped enclosure and is essentially a five-sided enclosure for exhibitor utilities. The dimensions are approximately 16″ wide by 24″ long and 24″ deep. However, these dimensions can vary dependent upon the needed depth of the ice box and other considerations.

Inasmuch as the floorbox assembly of the invention is water tight, it also finds use in applications in an outdoor environment. The gasketing used in the floorbox assembly is metal sheathed, as indicated, so that it is impervious to oils and acids. It may also be used for indoor and outdoor fuel kits, and aircraft and ship-shore power utilities.

The floorbox of the invention provides the positive functionality of a convention center of the type in which no ice floor arrangement has been employed. This device will provide for water tightness and thermal conduction away from the ice sheet. It is also used as a heat sink to keep the ice over the floorbox cavity at least as cold and, consequently, as hard as the ice over the concrete floor. In short, there will be no soft spot in the ice over the floorbox.

In use, the box forming part of the utility floorbox assembly is pre-constructed as an assembly of components and which are mounted to reinforcing bar or other structural members in the forming of the building or other facility in which the floorbox is used. More specifically, the floorbox assembly is actually mounted in the facility during rough construction and the concrete floor is poured around the floorbox assembly so that the latter becomes integral with the floor, surrounded by a rim on its upper end. The rim is designed to hold a frame which, in turn, receives the brine piping extending through the floor. Moreover, this entire assembly is then covered by the cover which has the hinged end sections capable of being opened for access to the utilities.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a top plan view of a brine piping floorbox arrangement used in the present invention;

FIG. 2 is an exploded perspective view showing the main components forming part of the floorbox assembly and a portion of a vault in a floor;

FIG. 3 is a vertical sectional view showing the arrangement of the cover and the frame and a rim in a floorbox assembly;

FIG. 4 is an enlarged corner view showing a portion of the installation of FIG. 3, as identified in the circled area of FIG. 3;

FIG. 5 is a perspective view of a rim used in the floorbox assembly of the present invention;

FIG. 6 is an end elevational view taken along line 6-6 of FIG. 5;

FIG. 7 is a side elevational view of the metal sheathed rim of FIG. 5, taken along line 7-7 of FIG. 5;

FIG. 8 is a perspective view of a frame used in accordance with the present invention and which is received by the rim of FIGS. 5-7 and which, in turn, receives a hereafter described cover;

FIG. 9 is a perspective view of a cover plate used with the floorbox assembly of the present invention;

FIG. 10 is a transverse end elevational view of the cover of the invention taken substantially along the plane of 10-10 of FIG. 9;

FIG. 10A is a transverse side elevational view, similar to FIG. 10, and showing one of the hinged access leafs being folded upwardly to obtain access to a potential utility located thereunder;

FIG. 11 is a side elevational view of the cover of the invention taken substantially along the plane of line 11-11 of FIG. 9;

FIG. 12 is a fragmentary vertical sectional view taken along line 12-12 of FIG. 9;

FIG. 13 is a longitudinal sectional view along line 13-13 of FIG. 9;

FIG. 14 is a transverse sectional view showing a portion of the rim and the frame and the cover assembly in relation to a floor structure, such that ice may be formed over the floor structure and the cover assembly of the invention;

FIG. 15 is a fragmentary enlarged elevational view showing the 180° rotatable hinge arrangement for the cover or lid of the present invention;

FIG. 16 is an enlarged perspective view of a component of a double hinge assembly used with the cover of FIG. 14; and

FIG. 17 is a sectional view, similar to FIG. 15, and showing a utility access panel opened to a 180° position with respect to the normal closed position.

### DETAILED DESCRIPTION OF A PREFERRED EMBODIMENT

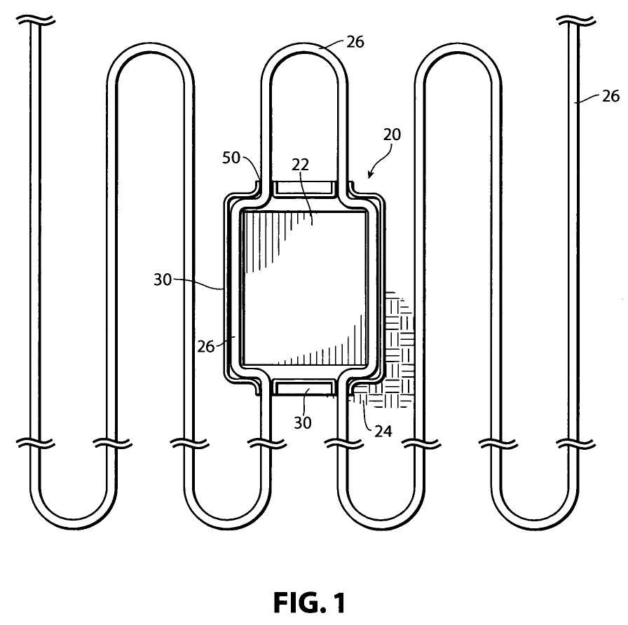

Referring now in more detail and by reference characters to the drawings which illustrate a preferred embodiment of the present invention, 20 designates a metallic floorbox assembly having a floorbox 22 which is constructed in and becomes a permanent part of a floor of a facility in which the floorbox would be used. In this case, the floorbox 22 is shown as being rectangular in shape, although it could be constructed in any desired shape. Moreover, by reference to FIG. 1, it can be observed that a liquid coolant pipe 26 extends around portions of the floorbox assembly 20 of the invention. This coolant pipe is extended around the floorbox 22 and through a serpentine pattern beyond the floorbox and under the floor, for at least that portion of the floor which is going to be ice cold.

In a preferred embodiment, the coolant is a brine, namely a salt saturated water for purposes of reducing the freezing temperature of the water below the normal freezing temperature. Any other coolant can be used. The ends of the brine pipe 26 are shown as broken away, whereas in reality, they would be connected to a cooling system.

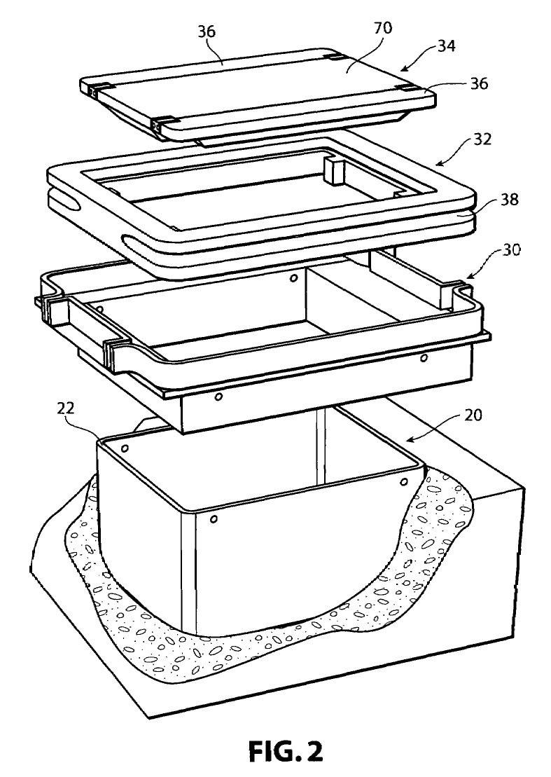

FIG. 2 illustrates, in exploded assembly form, the major components of the floorbox assembly. Provided for disposition in an opening formed in the floor is a rim 30, which, in turn, receives and holds a frame 32 and which surrounds the floorbox 22. As indicated previously, the floorbox 22 actually is bolted to the rim 30 and which is, in turn, secured within the floor. The concrete forming part of the floor is poured around and thereby rigidly holds the floorbox 22. In that construction, the floorbox then becomes a permanent part of the floor. The upper end of the floorbox 22 fits within the rim 30 and in that position holds the frame 32 in a manner to be hereinafter described in more detail. Provided for closurewise disposition over the frame and rim is a cover 34. This cover 34 is provided with longitudinally extending hinged end plates 36 which can be folded upwardly with respect to the remainder or so-called bridge 70 of the cover 34. Each of these components forming part of the floorbox assembly 20 is hereinafter described in more detail.

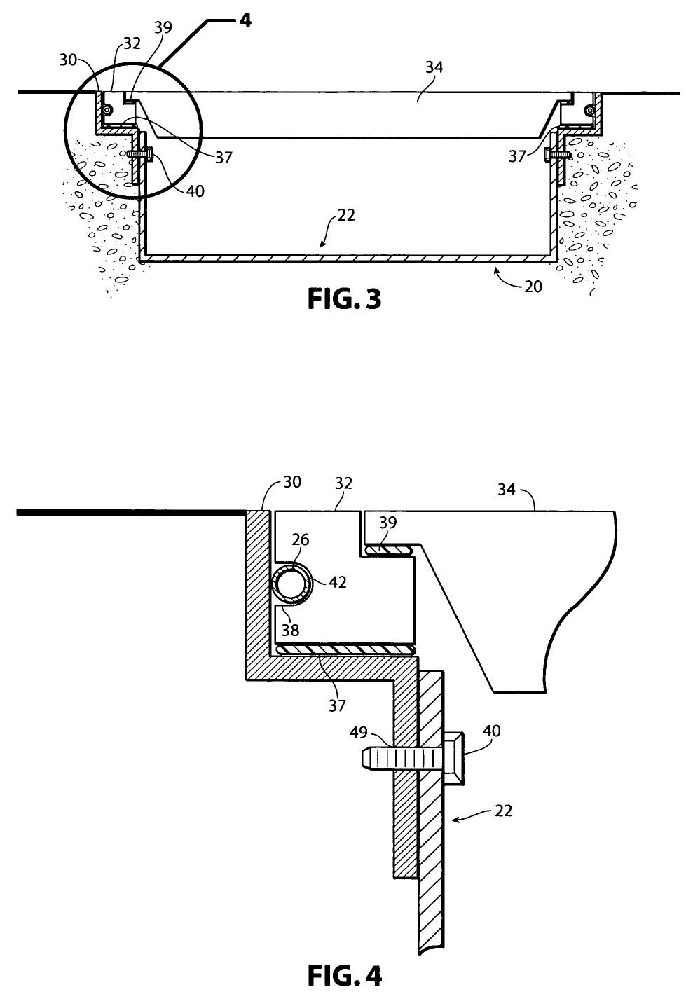

FIGS. 3 and 4 show the relationship of the rim 30 and the frame 32 with respect to the floorbox assembly 20 which also show the positioning of the cover 34 over the otherwise opened upper end of the floorbox 22. It should also be understood that in place of transverse end access plates, it is possible to use longitudinally extending access plates in the cover 34. In the latter event, the same hinge mechanism (hereinafter described) which is used for the transverse access plates, would also be used for longitudinally extending access plates.

FIG. 4 shows in more detail the arrangement of the rim 30 and the frame 32 with respect to the floorbox 22, as well as the cover 34. In FIG. 4 it can be seen that the box 22 is mounted to the rim 30 after the latter is secured within the floor and the frame 32 is mounted on the rim 30. Moreover, they are covered by the cover 34. In addition, a metal sheathed gasket 39 is interposed between the lower surface of the cover 34 and the frame 32. This metal sheathed gasket 39 would extend peripherally around the entire undersurface of the cover 34. There is also a metal sheathed gasket 37 located between the frame 32 and the rim 30.

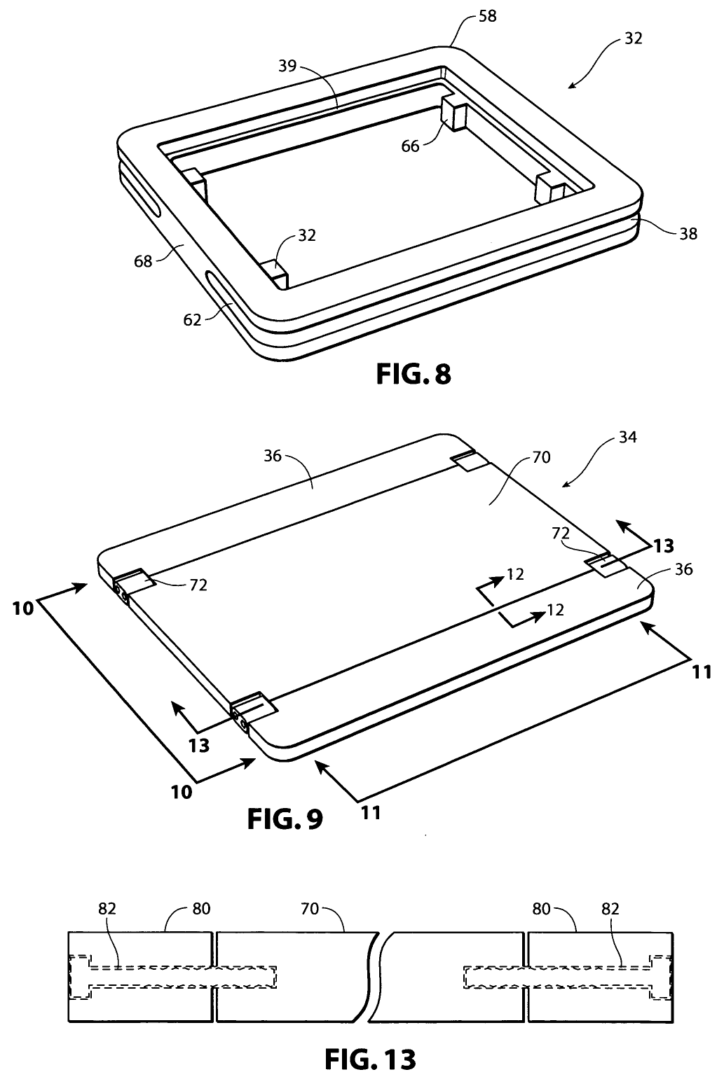

The frame 32 is provided along at least its longitudinal sides with semi-circular recesses 38 (see FIGS. 4 and 8) for receiving a coolant pipe 26. This coolant pipe 26 is designed to carry a coolant, such as a brine coolant, as previously described. Moreover, it can be observed, by reference to FIGS. 3 and 4, that the floorbox 22 may be bolted to the rim 30 by means of bolts or screws 40, which extend through openings 49 (See FIG. 7) in the rim 30.

By further reference to FIG. 4, it can be observed that a heat conducting paste 42, similar to that used in electronic heat sinks for power transistors, is used around the floorbox assembly. However, and although a heat conducting paste has been found to be effective, other forms of heat conducting material, including, for that matter, metal filings or the like, could be disposed in the space between the exterior surface of the brine conveying pipes 26 and the wall of the rim 30. It can be observed that the heat conducting paste is also effective for securing the brine pipes 26 to the wall of the rim and provides thermal conductivity therebetween.

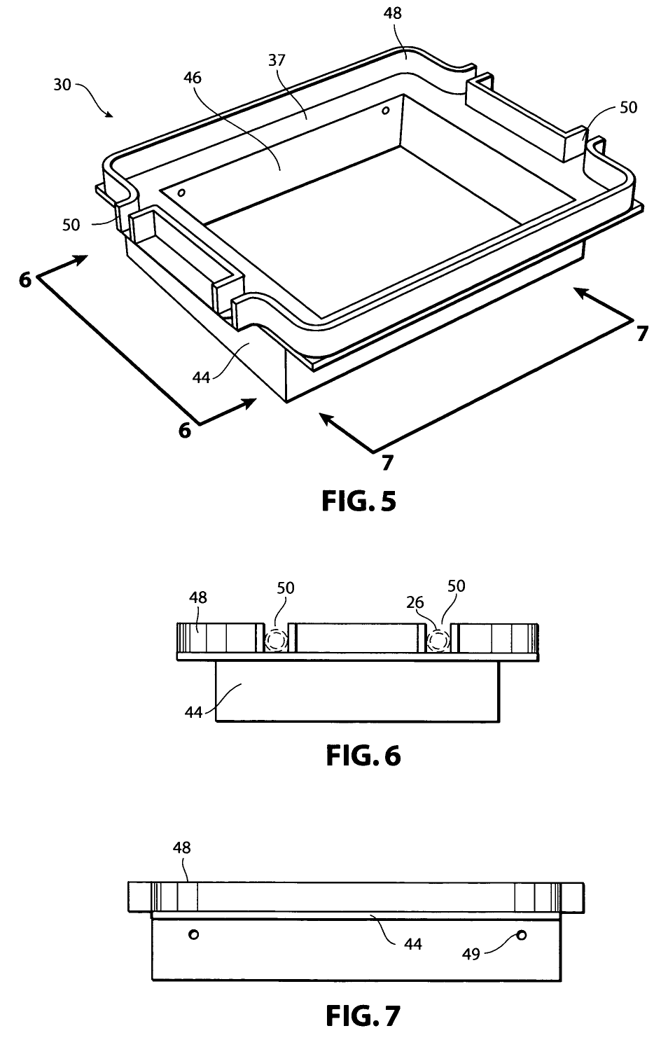

The rim 30 is more fully illustrated in FIGS. 5-7 of the drawings. In this case, it can be observed that the rim 30 is provided with a rectangularly arranged rim-forming wall 44 and which also defines an enlarged opening 46, as shown. The rim 30 also includes an upstanding wall 48, as best shown in FIGS. 6 and 7. In addition, the upstanding wall 48 is provided with the openings 50 to allow for extension of coolant pipes 26. A metal sheathed gasket 37 rests on the upper surface of the rim 30 and extends beneath the lower surface of the frame 32. In addition, heat conducting paste could also be used where the brine pipes 26 extend through the openings 50 in the upstanding wall 48. In this way, the coolant or brine pipes can surround the floorbox in intimate contact with, or in closely spaced relationship to, the floorbox.

The rim is preferably constructed of black steel and in cross-section has somewhat of a Z-shape configuration. Moreover, the rim should be galvanized to avoid corrosion. The rim 30 is actually designed to provide a smooth transition for the brine piping and in conjunction with the floorbox it functions as a form for the concrete floor. There are provided the plurality of openings 49 (See FIG. 7) for securing the rim to reinforcing bars in the concrete. This will preclude the utility floorbox from floating out of position when the concrete is poured.

It can be observed by the above outlined construction that the rim and floorbox are in direct contact with the concrete floor. This arrangement will thereby provide effective heat transfer to the concrete. The rim also serves to transfer all of the wheel loads imposed on the floorbox assembly into the concrete structure of the floor. Inasmuch as the rim is in direct contact with the concrete floor, it will transfer heat into the concrete and thereby draw heat away from the floorbox.

Furthermore, there are the two metal sheathed gaskets 37 and 39 which provide both for water tightness and for thermal conductivity. It has been found in connection with the present invention that rubber gaskets, such as neoprene rubber gaskets, which are thermal insulators, do not allow for effective heat transfer, and are, therefore, ineffective for use in the floorbox assembly of the present invention.

In ice floors, the brine piping is typically spaced on approximately 8 inch centers in one direction. As a result, the floorbox of the invention will normally be about 16 inches by 24 inches on the inside of the enclosure. Therefore, provision for the brine piping must be made with minimal impact on this spacing. As a result, with the floorbox assembly design of the invention, there will only be a displacement of about 24 inches of brine piping, and, moreover, a thermal conductor, which is actually better than the concrete, will be used in its place.

The frame 32 forming part of the floorbox assembly is best shown in FIG. 8 of the drawings. The frame is preferably formed of a cast aluminum in a rectangular frame configuration with a continuous side wall 68 having rounded corners 58. Formed in the rounded corner portions of the frame 32 are arcuately shaped recesses 38 which are sized to receive the brine pipes as they may extend around the frame of the floorbox assembly. In addition, the recesses or grooves 38 have side wall portions 62 which extend along the side walls of the frame, all as best shown in FIG. 8 of the drawings. The frame may also be provided with the metal sheathed gasket 39. In effect, this gasket 39 will be located between and in contact with the frame and the cover or lid 34, as shown in FIG. 4 and as hereinafter described in more detail. In addition, a heat conducting paste 42 of the type previously described may be also used to fill the void between the brine piping and the frame in order to maximize heat transfer.

In accordance with this above-described construction, it can be observed that the frame will provide a path for heat transfer from the cover to the brine piping and the rim to the concrete floor. The frame will transfer all of the wheel loads imposed on the cover to the rim, as well. The frame is also integrally provided with four inwardly extending end projections 66 on a pair of the opposite end walls 68, as best shown in FIG. 8. These projections extend inwardly only to a distance sufficient to support the hinges in the cover (as hereinafter described) and also to provide a place for the gasket to achieve water tightness.

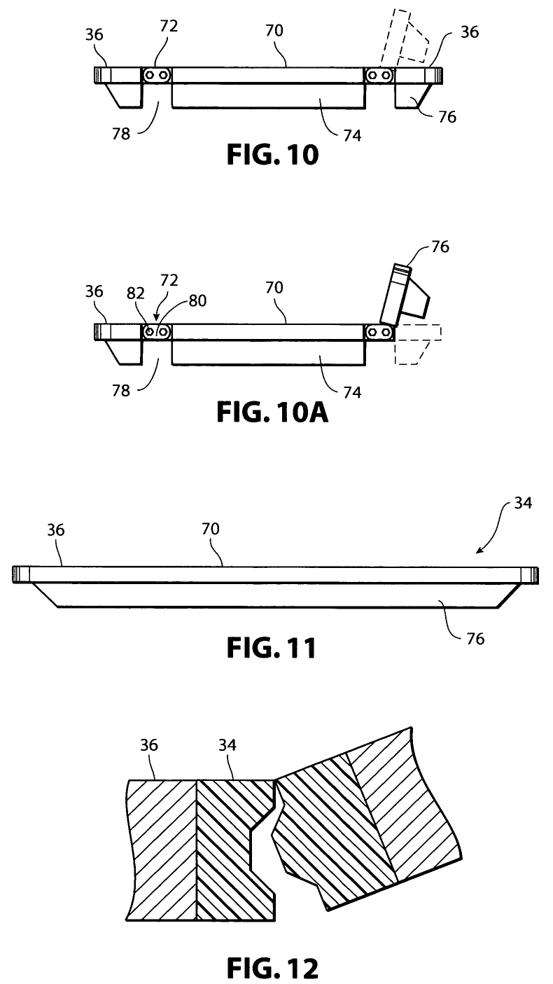

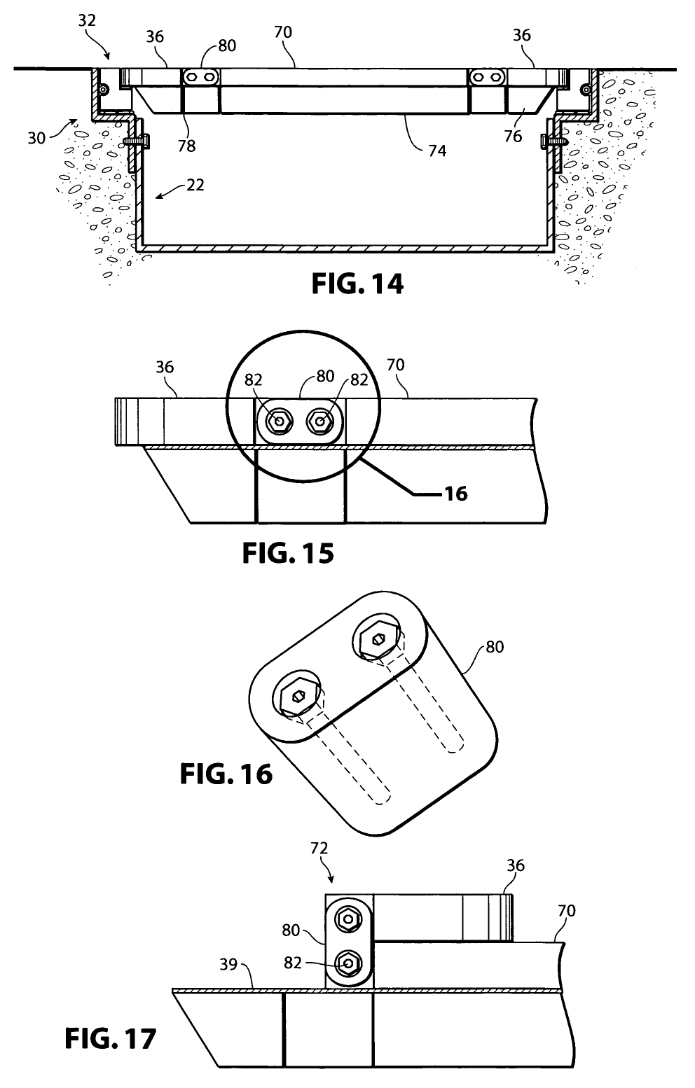

The cover or lid of the invention is best illustrated in FIGS. 9-17 of the drawings. This cover 34 is comprised of the main flat center plate or bridge 70 upon which the hinged end access plates 36 are mounted. The access plates 36 are secured to the main flat plate 70 by means of hinge structures 72, the latter of which are more fully illustrated in FIGS. 13-17 of the drawings. By reference to FIGS. 10, 10A, 11 and 12, it can be seen that the end access plates 36 can be folded over through a 180° movement, so that they are disposed on and can lay on the upper surface of the flat plate 70.

The flat plate 70 is provided on its underside with a pair of downwardly extending wings 74, as best shown in FIGS. 10 and 10A. In this case, the end access plates 36 are each also provided with downwardly extending wings 76 providing a space 78 between the wings 74 and 76, as best shown in FIGS. 10 and 10A. The wings 74 and 76 are representation of a structural design to minimize weight and therefore the overall cost of the cover assembly. However, other cover configurations could be used in the invention.

Transverse endwise extending wings 76 are also formed on the flat plate 70. These wings 76 aid in transferring loads from the cover plate 70 to the frame. In this way, the cover must withstand a 32,000 pound load on a platform plate on a 1″ by 16″ footprint anywhere within the cover. Moreover, this cover plate must transfer all heat to the frame. In addition, it must be water tight when not in use. Finally, it must provide easy access to the utilities contained in the utility box assembly.

The cover or main plate 70 is frequently referred to as a bridge and generally provides a closure to the utility box. As indicated, it must support a very heavy wheel load or other load over the full length of the box.

The hinges 72 are required so that access may be obtained to the utilities located on the inside of the utility box. These hinges are double pin hinges having a link 80 with hinge pins 82 in the manner as shown in FIGS. 13-17. In accordance with this design, they will rest on the surface when in use. The hinges can achieve the 180° opening of access and still have a flat floor when not in use. In actuality, shoulder bolts can be used for the hinge pins. They would be anchored in the flat plate or bridge 70.

FIG. 17 shows the positioning of the hinge 72 when the access plates 36 are fully opened through a 180-degree arc. Moreover, they rest upon the metal sheathed gasket 39 on the upper surface of the frame and which upper surface actually functions as a hinge support.

The invention provides the added capability of allowing for ice floors over the floorbox itself while still allowing use with dry floors. Moreover, the device will provide water tightness, as well as thermal conduction away from the ice sheet. In addition, the floorbox can be used as a heat sink to cover the ice over the floorbox, so that the latter is at least as cold and therefore as hard as the ice covering the concrete floor. In short, there will be no ice soft spot in the ice over the floor.

The gaskets, which are used, eliminate hard contact between the lid and the floorbox. However, they are deformable to relieve stresses and also they will conduct heat. In this way, all loads will be introduced into the concrete.

Thus, there has been illustrated and described a unique and novel utility floorbox for use with ice covered floors and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

1. A utility floorbox assembly capable of being used with dry floors and ice covered floors and having provision for coolant pipes, said floorbox assembly comprising:
a) a box capable of being located with respect to a floor which has one or more utility lines extending thereto;
b) means associated with said box for allowing a pipe connected to or forming part of said coolant pipe to extend around in closely located arrangement to said box so that there is heat transfer between said pipe and said box; and
c) cover means disposed over an opened upper end of said box to provide for heat transfer and to carry loads imposed on said floorbox assembly.

2. The utility floorbox assembly of claim 1 further characterized in that said floorbox assembly comprises:
a) a frame used with an upper portion of said box and which has recesses to receive the coolant pipe and to receive a load imposed on said box.

3. The utility floorbox assembly of claim 2 further characterized in that the recesses are sized so that they receive the coolant pipe and are located in heat transfer relationship to said box and said cover means.

4. The utility floorbox assembly of claim 2 further characterized in that said cover means is located over said frame and has a portion which can open providing access to said utility box.

5. The utility floorbox assembly claim 2 further characterized in that a rim is interposed between said utility box and said frame.

6. The utility floorbox assembly of claim 1 further characterized in that said rim has a metal sheathed gasket extending around a portion thereof.

7. The utility floorbox assembly of claim 1 further characterized in that a metal sheathed gasket extends between said rim and said frame.

8. A utility floorbox assembly capable of being used with dry floors and ice covered floors, said floorbox assembly comprising:
a) a box capable of being located with respect to a floor and in heat transfer contact with material forming the floor;
b) a rim located on an upper end of said floorbox said rim having means to receive a coolant pipe, when a coolant pipe is present;
c) a frame capable of being carried by said rim and which is also in heat transfer contact to the floor through the rim; and
d) a cover disposed over an open upper end of said box and having an openable portion allowing for access to a utility enclosed in said box, said cover also being in heat transfer contact to said coolant pipe, when a coolant pipe is present, through said rim and frame.

9. The utility floorbox assembly claim 8 further characterized in that said box and rim and frame and cover are connected in a water tight manner to preclude water leaks into the interior of said box.

10. The utility floorbox assembly of claim 8 further characterized in that said cover is connected to said frame in such manner to transfer loads on the cover and box and frame to the floor material.

11. The utility floorbox assembly of claim 8 further characterized in that the cover, rim and the frame are connected to liquid coolant pipes to draw heat away from the floorbox through a complete metal-to-metal path.

12. The utility floorbox assembly of claim 11 further characterized in that said floorbox assembly comprises:
a) a complete thermally conducting path through the cover, rim, frame and floorbox to the coolant pipe, when the coolant pipe is present.

13. The utility floorbox assembly of claim 8 further characterized in that said frame is formed of a metal which provides a heat transfer path from the floor to the coolant pipe.

14. The utility floorbox assembly of claim 8 further characterized in that said frame comprises:
a) a plurality of inwardly struck projections which are located to support a cover; and
b) a gasket is used with said frame to provide water tightness in the interior of said box.

15. The utility floorbox assembly of claim 8 further characterized in that said cover comprises:
a) a central bridge component;
b) at least one hingedly mounted access plate on said cover and which is swingable out of a cover position to obtain access to said utility box.

16. The utility floorbox assembly claim 15 further characterized in that said hinges are double-pin hinges so that the access plate can lie flat on the cover when moved to the open position.

17. A utility floorbox assembly capable of being used with dry floors and floors which may contain water thereon, said floorbox assembly comprising:
a) a utility box capable of being located in a floor;
b) means associated with said box to maintain coolant lines with respect to the floorbox in heat conducting relationship therewith; and
c) metal sheathed gaskets to not only provide for resistivity to water leaks, but which also functions as a heat sink to keep the ice over the utility floorbox assembly at least as cold as the ice over the remaining portion of the floor.

18. The utility floorbox assembly of claim 17 further characterized in that said floorbox assembly comprises means to receive a coolant pipe extending around a portion of the floorbox and in closely located arrangement to the box, so that there is an effective heat transfer between the coolant pipe and the box.

19. The utility floorbox assembly of claim 17 further characterized in that cover means is disposed over an open end of said box to provide for heat transfer and to also carry loads imposed on said box and transfer same to the floor structure.

20. The utility floorbox assembly of claim 17 further characterized in that a cover is disposed over said floorbox and has at least one access opening to provide access to the interior of the floorbox.

21. The utility floorbox assembly of claim 17 further characterized in that said floorbox assembly comprises:
a) a metal rim located between the floorbox and a portion of the floor structure providing a complete thermally conducting path between the cover, frame, the rim, and the floorbox to the floor structure.

22. The utility floorbox assembly of claim 21 further characterized in that said frame comprises:
a) a plurality of inwardly struck projections which are located to support a cover; and
b) a gasket is used with said frame to provide water tightness in the interior of said box.

23. The utility floorbox assembly of claim 21 further characterized in that said cover comprises:
a) a central bridge component;
b) at least one hingedly mounted access plate on said cover and which is swingable out of a cover position to obtain access to said utility box.

24. A method of providing utility access in a facility having a floor which is capable of both being used in dry conditions and with water on the floor, said method comprising:
a) securing a utility floorbox in said floor;
b) providing a frame having recesses to receive a coolant pipe around said floorbox, said frame capable of supporting weight of a cover and any weight which may be imposed on the cover and transferring same to the surrounding floor structure; and
c) providing a removable cover over said floorbox which cooperates with said frame in transferring loads to the rim and hence to the floor.

25. The method of claim 24 further characterized in that said cover comprises:
a) a bridge section which extends over a portion of the open upper end of said floorbox; and
b) a hingeable access plate which is capable of being opened to provide access to the interior of said floorbox.
